(19) United States
(12) Patent Application Publication
(10) Pub. No.: US 2014/0162640 A1
(43) Pub. Date: Jun. 12, 2014

(54) SYSTEM AND METHOD FOR SUBSCRIPTION DATA OPTIMIZATION

(71) Applicants: Xipeng Zhu, Beijing (CN); Krishna S. Pandit, Nuernberg (DE); Patrick Stupar, Nuernberg (DE); Wolfgang Granzow, Nuernberg (DE)

(72) Inventors: Xipeng Zhu, Beijing (CN); Krishna S. Pandit, Nuernberg (DE); Patrick Stupar, Nuernberg (DE); Wolfgang Granzow, Nuernberg (DE)

(21) Appl. No.: 13/805,324

(22) PCT Filed: Jun. 28, 2010
(86) PCT No.: PCT/CN2010/074582

§ 371 Date: Jun. 25, 2013

(51) Int. Cl. H04W 8/04; H04W 8/12; H04W 8/06

(52) U.S. Cl. CPC H04W 8/04; H04W 8/06; H04W 8/12
USPC 455/435.1

(57) ABSTRACT

Devices and methods are provided for subscription data optimization in a wireless communication system. In one embodiment, the method may involve receiving an update location request from a mobile entity and forwarding the update location request to a subscriber data repository. The method may involve receiving a profile identifier from the subscriber data repository, the profile identifier corresponding to profile parameters for a subscription service for the mobile entity. The method may also involve accessing a lookup table to determine the profile parameters associated with the profile identifier, and determining whether to authorize the subscription service based at least in part on the profile parameters.

### BACKGROUND

1. Field

The present application relates generally to wireless communications, and more specifically to systems and methods for subscription data optimization.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3rd Generation Partnership Project (3GPP) Long Term Evolution (LTE) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A wireless network operator typically has many subscribers (e.g., millions) but may use only relatively few different sets of subscription data for its subscribers. The subscription data is often highly duplicated or identical among subscribers. The trend toward increasing numbers of wireless subscribers and increasing amounts of subscription data for each subscribers will likely result in further resource demands within the wireless network. Accordingly, there is a need to use the duplicative nature of groups of subscription data to optimize the storage and delivery of the subscription data, and thereby achieve a more efficient utilization of network resources.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with methods for subscription data optimization in a wireless communication network. The method may be performed at an infrastructure entity, such as a network managing entity (e.g., a Serving GPRS Support Node (SGSN) or a Mobility Management Entity (MME), wherein GPRS stands for General Packet Radio Service). The method may involve receiving a registration request from a mobile entity. The registration request may comprise an attach request or location registration request, and may comprise an identity of the mobile entity. In related aspects, the registration request may include a subscriber identity, such as, for example, an International Mobile Subscriber Identity (IMSI), a Temporary Mobile Subscriber Identity (TMSI), or other identity. The generic term mobile entity identity (ME-ID) may be used to refer to the identity used in messages exchanged between a mobile entity and a network management entity.

The method may involve sending an update location request to a subscriber data repository, such as, for example, a Home Location Register (HLR) or a Home Subscriber Server (HSS). The method may involve receiving subscriber data from the subscriber data repository. The subscriber data may comprise a profile identifier, or the like, corresponding to profile parameters for a subscription service for the mobile entity. The method may involve accessing a lookup table to determine the profile parameters associated with the profile identifier. In essence, a profile identifier may be used to replace the associated profile parameters in a subscription data storage, delivery, and processing. In related aspects, the method may further involve determining whether to authorize the subscription service based at least in part on the profile parameters. In further related aspects, an electronic device may be configured to execute the above described methodology.

In another embodiment, the profile identifier may be stored on and transmitted from a mobile entity to the network management entity. For example, the method may involve receiving a registration request from the mobile entity, the update location request comprising an identity of the mobile entity and a profile identifier corresponding to profile parameters for a subscription service for the mobile entity. The profile identifier may be integrity protected and encrypted. The method may involve sending an update location request to a subscriber data repository, and receiving subscriber data from the subscriber data repository.

In accordance with one or more embodiments and corresponding disclosure thereof, various aspects are described in connection with a subscription data optimization method that may be performed by a mobile entity. In one embodiment, the method may involve sending a registration request to a network management entity, such as, for example, one or more of a Serving GPRS Support Node (SGSN), a Mobility Management Entity (MME), a Mobile Switching Center (MSC)/Visitor Location Register (VLR), and a Serving Call Session Control Function (S-CSCF). The registration request may include an identity of the mobile entity and a profile identifier corresponding to profile parameters for a subscription service for the mobile entity. The method may involve receiving an authorization message from the network management entity based at least in part on the profile parameters. In related aspects, the authorization message may comprise one of an approval or denial for the subscription service. In further related aspects, an electronic device may be configured to execute the above described methodology.

In accordance with one or more embodiments and corresponding disclosure thereof, various aspects are described in connection with a subscription data optimization method that may be performed by an infrastructure entity, such as, for example, a subscriber data repository (e.g., a HLR or a HSS). In one embodiment, the method may involve receiving an update location request from a network management entity (e.g., an SGSN or a MME). The update location request may include a subscriber identifier, such as, for example, an IMSI. The method may involve sending subscriber data to the network management entity, the subscriber data comprising a profile identifier corresponding to profile parameters for a subscription service for the mobile entity. In related aspects, sending the subscriber data may involve transmitting the identity of the mobile entity and other parameters to the network management entity. In further related aspects, an electronic device may be configured to execute the above described methodology.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 illustrates a multiple access wireless communication system.

FIG. 2 provides a block diagram showing Home Subscriber Server (HSS) data storage for Evolved Packet System (EPS) and General Packet Radio Service (GPRS).

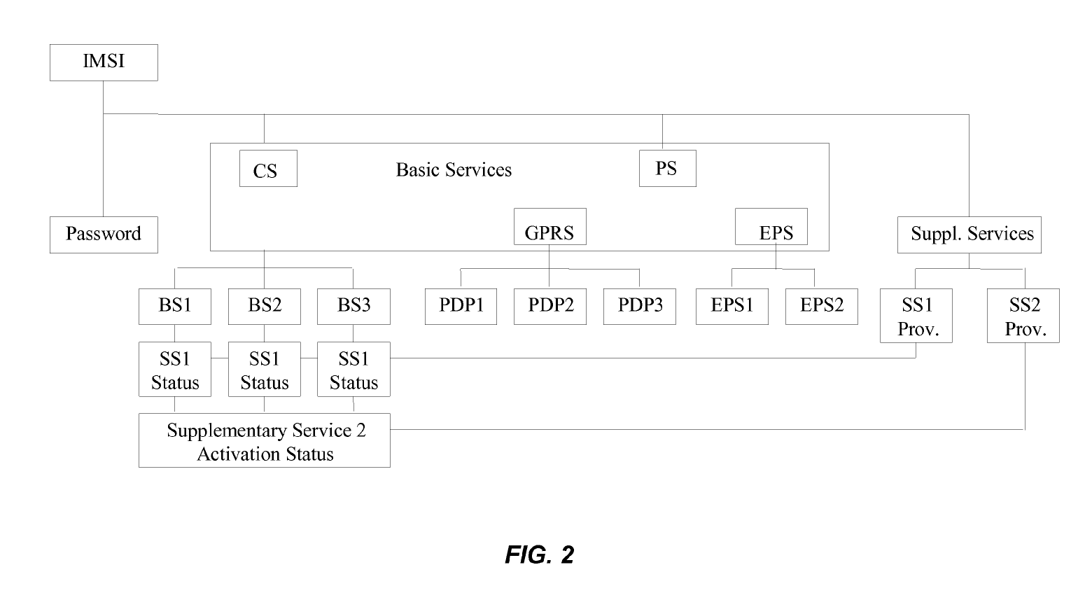

FIG. 3 shows a call flow diagram for an exemplary technique for subscription data optimization.

FIG. 4 shows a call flow diagram for another exemplary technique for subscription data optimization.

FIG. 5 illustrates an example methodology for subscription data optimization by a infrastructure entity, such as a network management entity.

FIG. 6 illustrates further aspects of the methodology of FIG. 5.

FIG. 7 is a schematic drawing of part of the hardware implementation of an apparatus executing a profile parameters determination process in accordance with the exemplary embodiment.

FIG. 8 illustrates another example methodology for subscription data optimization by a infrastructure entity, such as a network management entity.

FIG. 9 illustrates further aspects of the methodology of FIG. 8.

FIG. 10 is a schematic drawing of part of the hardware implementation of an apparatus executing another profile parameters determination process in accordance with the exemplary embodiment.

FIG. 11 illustrates an example methodology for subscription data optimization by a mobile entity.

FIG. 12 is a schematic drawing of part of the hardware implementation of an apparatus executing a profile identifier sharing process in accordance with the exemplary embodiment.

FIG. 13 illustrates an example methodology for subscription data optimization by a infrastructure entity, such as a subscriber data repository.

FIG. 14 is a schematic drawing of part of the hardware implementation of an apparatus executing a subscriber data sharing process in accordance with the exemplary embodiment.

### DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. In the following description, for reasons of conciseness and clarity, terminology associated with W-CDMA and LTE standards, as promulgated under the 3GPP standards by the International Telecommunication Union (ITU), is used. It should be emphasized that the invention is applicable to other technologies, such as the technologies and standards mentioned above.

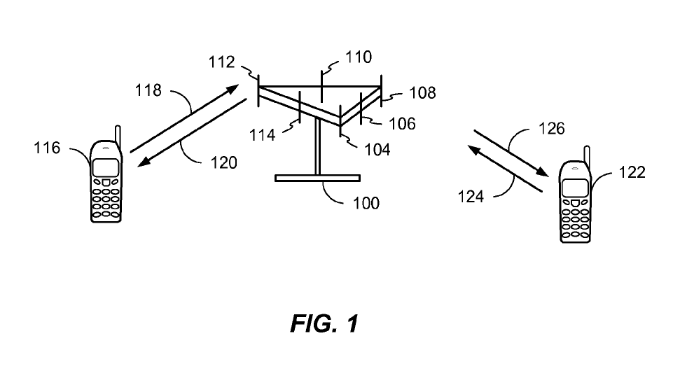

Referring to FIG. 1, a multiple access wireless communication system according to one embodiment is illustrated. An access point 100 (e.g., base station, Evolved Node B (eNB), or the like) includes multiple antenna groups, one including 104 and 106, another including 108 and 110, and an additional including 112 and 114. In FIG. 1, two antennas are shown for each antenna group, however, more or fewer antennas may be utilized for each antenna group. A mobile entity, such as an access terminal (AT) or user equipment (UE) 116 is in communication with the antennas 112 and 114, where the antennas 112 and 114 transmit information to the UE 116 over a forward link 120 and receive information from the UE 116 over a reverse link 118. A UE 122 is in communication with the antennas 106 and 108, where the antennas 106 and 108 transmit information to the UE 122 over a forward link 126 and receive information from the UE 122 over a reverse link 124. In a FDD system, the communication links 118, 120, 124 and 126 may use different frequency for communication. For example, the forward link 120 may use a different frequency then that used by the reverse link 118.

Each group of antennas and/or the area in which they are designed to communicate is often referred to as a sector of the access point. In the embodiment, antenna groups each are designed to communicate to UEs in a sector, of the areas covered by the access point 100.

In communication over the forward links 120 and 126, the transmitting antennas of the access point 100 utilize beamforming in order to improve the signal-to-noise ratio of forward links for the different UEs 116 and 124. Also, an access point using beamforming to transmit to UEs scattered randomly through its coverage causes less interference to UEs in neighboring cells than an access point transmitting through a single antenna to all its UEs.

An access point may be a fixed station used for communicating with the terminals and may also be referred to as an access point, a Node B, an eNB, or some other terminology. A mobile entity may also be referred to as a UE, a wireless communication device, terminal, or the like.

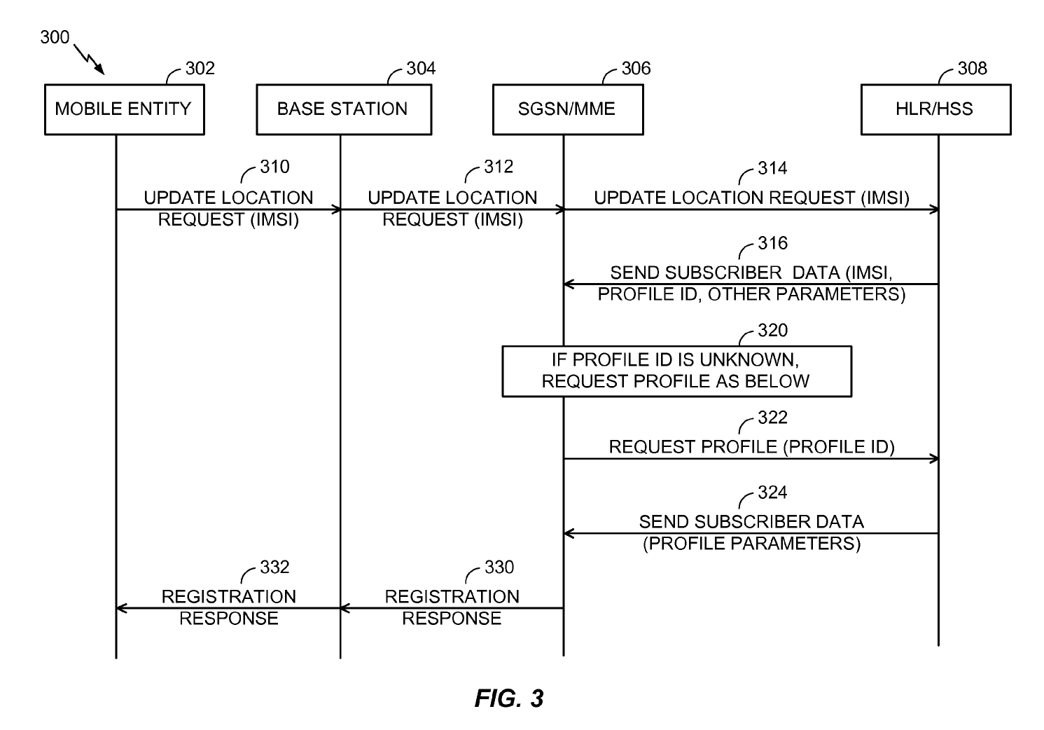

In accordance with one or more aspects of the embodiments described herein, there are techniques for subscription data optimization in a wireless communication. As noted above, the subscription data records of mobile network subscribers include a large amount of parameters which are identical for many users. The subscription data may include a subscriber's basic service configuration parameters based on the contract with the operator. The subscription data may be maintained in a subscriber data repository, such as, for example, a Home Location Register (HLR) in a 3G system or a Home Subscriber Server (HSS) in a 4G system. The subscription data may include Circuit Switched (CS) subscription data, General Packet Radio Service (GPRS) subscription data, Evolved Packet System (EPS) subscription data, and/or supplementary services subscription data, as shown in FIG. 3. Depending on the type of the subscriber, the subscription data may also include Machine to Machine (M2M) specific subscriptions, Internet Protocol Multimedia Sub-system (IMS) subscriptions, etc. With continued reference to FIG. 3, there is shown the HSS data storage for EPS and GPRS, which includes subscription data and some dynamic data elements. Examples of the types of GPRS/EPS subscription data contained in the HLR/HSS may include but are not limited to:

| Field | Description |
|---|---|
| International Mobile | IMSI is the main reference identifier for a subscriber. |
| Subscriber Identity | |
| (IMSI) | |
| Mobile Station | The basic MSISDN of the mobile entity. |
| Integrated Services | |
| Digital Network | |
| (MSISDN) | |
| Serving GPRS Support | The SS7 number of the SGSN currently serving the mobile |
| Node (SGSN) Number | entity. |
| SGSN Address | The Internet Protocol (IP) address of the SGSN currently |
| | serving the mobile entity. |
| Subscribed Charging | The charging characteristics for the mobile entity (e.g., |
| Characteristics | normal, prepaid, flat-rate, and/or hot billing subscription). |
| Trace Reference | Identifies a record or a collection of records for a particular |
| | trace. |
| Trace Type | Indicates the type of trace, e.g. Mobile Switching Center |
| | (MSC)/Base Station System (BSS) trace, Home Location |
| | Register (HLR) trace, and/or SGSN/Gateway GPRS Support |
| | Node (GGSN)/BSS trace. |
| Operations & | Identifies the OMC that shall receive the trace record(s). |
| Maintenance Center | |
| (OMC) Identity | |
| Short Message Service | SMS-related parameters (e.g., operator-determined barring). |
| (SMS) Parameters | |
| Mobile Not Reachable | Indicates that the mobile entity is not reachable through an |
| for GPRS (MNRG) | SGSN, and that the mobile entity is marked as not reachable |
| | at the SGSN and possibly at the GGSN. |
| GGSN-list | The GPRS Support Node (GSN) number and optional IP |
| | address pair related to the GGSN that shall be contacted when |
| | activity from the MS is detected and MNRG is set. |
| Access Restriction | Indicates the access restriction subscription information. (The |
| | access restriction applies to both packet and circuit oriented |
| | services). |
| IMEI | International Mobile Equipment Identity |
| SVN | Software Version Number |
| RFSP Index | An index to specific RRM configuration in the |
| | UTRAN/GERAN |

Each subscription profile may also contain one or
more Access Point Name (APN) configurations:

| | |
|---|---|
| Packet Data Protocol | Index of the PDP/EPS Bearer context. |
| (PDP)/Evolved Packet | |
| System (EPS) Bearer | |
| Context Identifier | |
| PDP Type | PDP type, e.g., IPv4 or IPv6 |
| PDP Address | PDP address, e.g., an IP address. |
| Access Point Name | A label according to Domain Name System (DNS) naming |
| | conventions describing the access point to the packet data |
| | network. |

The IMSI is the primary identifier of the subscription data in HLR/HSS. Subscription data may include user identities (e.g., IMSI, MSISDN, GUTI, TMSI, P-TMSI), dynamic data (e.g., SGSN number, SGSN address, MNRG) and static data (e.g., APN subscriptions, Operator Determined Barring (ODB)). The static data is highly duplicated among subscriptions. For example, it is believed that China Mobile has more than 500 million subscribers but has less than one hundred kinds of tariffs. Subscribers of the same tariff type usually have same static subscription data. The overall size of subscription data per subscriber is large as the number of parameters increases with each 3GPP release. With the wide use of Packet Switched (PS) services, the PS domain subscription data delivery has significantly increased. Many operators have encountered HLR/HSS overload problems.

The basic concept of the proposed techniques for subscription data optimization is to utilize the duplication property by introducing a profile ID or identifier. A few subscriber profiles are defined and each profile is uniquely identified by a profile identifier. The subscriber data repository (e.g., HLR/HSS) may store the profile identifier instead of storing the whole static subscription data parameters. In essence, a profile identifier may be used to replace the associated profile parameters in a subscription data storage, delivery, and processing.

For example, subscription data is sent from the HSS to MSC/Visitor Location Register (VLR), SGSN, MME in Attach and Location Registration procedures, and sent to Serving Call Session Control Function (S-CSCF) in IMS registration. In subscription data transfer between network nodes, the profile identifier can be used to avoid including all the static subscription parameters explicitly into the message. Coming back to the China Mobile example above, having less than one hundred tariffs implies that for this operator it would be sufficient to define less than 100 subscriber profiles for 500 million subscribers.

With reference to FIG. 3, there is shown a call flow diagram for a first solution for handling the profile identifier. The profile identifier is stored in the subscriber data repository 308 (e.g., HLR/HSS). The system 300 may also include a mobile entity 302, a base station 304, and a network managing entity 306 (e.g., SGSN/MME) that are in operative communication with the data repository 308 and each other. At 310, the mobile entity 302 may send a registration request to the base station 304, wherein the registration request includes an identity of the mobile entity (ME-ID). The registration request may comprise an attach request or location registration request, or the like. At 312, the base station 304 may forward the registration request to the network managing entity 306, which in turn, at 314, may send an update location request to the subscriber data repository 308. In related aspects, the update location request may comprise a subscriber identifier, such as, for example, an IMSI or the like.

At 316, the subscriber data repository 308 may send subscriber data to the network managing entity 306, wherein the subscriber data may comprise the IMSI, the profile identifier, and optionally other parameters. At 320, if the network managing entity 306 does not know the profile identifier, the network managing entity 306 may request the profile identifier from the subscriber data repository 308. Specifically, at 322, the network managing entity 306 may send a request profile message to the subscriber data repository 308. At 324, the subscriber data repository 308 may send the subscriber data (including profile parameters) to the network managing entity 306.

The network managing entity 306 may access a lookup table or the like to determine the profile parameters associated with the profile identifier, and may determine whether to authorize a subscription service for the mobile entity 302 based at least in part on the profile parameters. At 330, the network managing entity 306 may send a registration response that may include an authorization message (e.g., approval or denial for the subscription service) to the base station 304. At 332, the base station 304 may forward the registration response to the mobile entity 302.

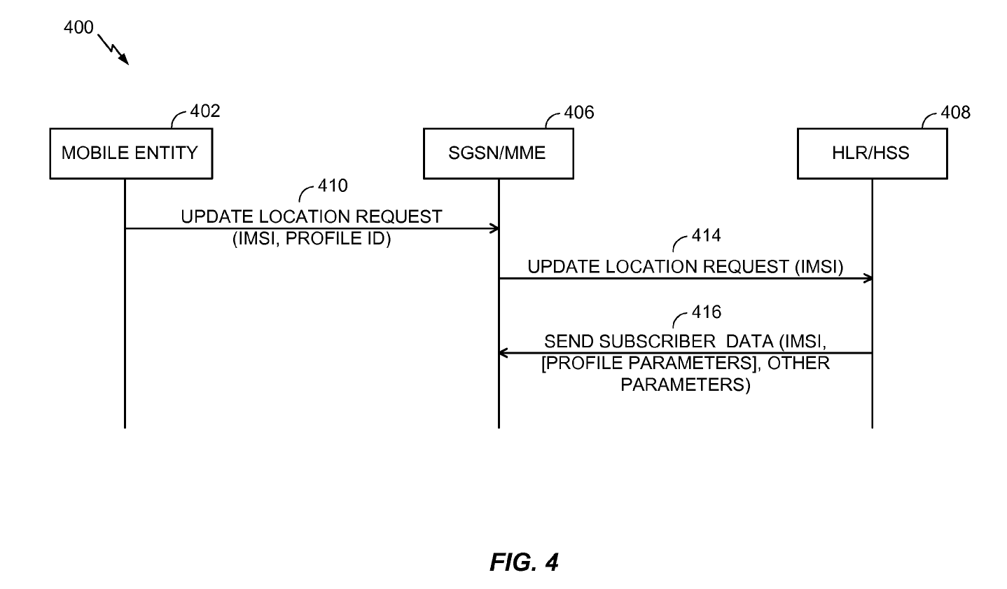

With reference to FIG. 4, there is shown a call flow diagram for a second solution for handling the profile identifier, wherein the profile identifier can be stored in a Universal Subscriber Identity Module (USIM) or the like, and transmitted from the mobile entity 402 to the network managing entity 406 (e.g., SGSN/MME) together with the ME-ID or the like (e.g., in the Attach and Tracking Area Update (TAU)/Routeing Area Update (RAU)/Location Area Update (LAU) procedures. Since the network managing entity 406 has the information whether it knows the profile identifier when sending the Update Location Request, 322 and 324 of FIG. 3 are not needed.

With continued reference to FIG. 4, at 410, the mobile entity 402 may send a registration request to the network managing entity 406, wherein the update location request may comprise and the ME-ID and the profile identifier. At 414, the network managing entity 406 may send an update location request (with an IMSI or the like) to the subscriber data repository 408. At 416, the subscriber data repository 408 may send the subscriber data to the network managing entity 406, wherein the subscriber data may comprise the IMSI, optionally the profile parameters, and/or optionally other parameters. Although not shown, the system 400 may comprise a base station that relays messages between the mobile entity 402 and the network managing entity 406. The other features and components of system 400 are otherwise similar to those of system 300 of FIG. 3.

In related aspects, the subscriber data optimization techniques can be added to the User Data Convergence (UDC) architecture. This can be realized in two ways. First, the UDC query procedure can be enhanced with a generic framework that allows handing of profile identifiers. The query procedure may be realized with Lightweight Directory Access Protocol (LDAP) or the like. Secondly, the UDC data model can be defined in a way that allows the data to be split into a dynamic and a static part. For example, if any profile is updated in the subscriber data repository, the subscriber data repository may send a update profile message to update the impacted network management entities, e.g. SGSN, MME, MSC/VLR, S-CSCF.

With the increase in subscription data size and subscription data transfer messages, it is necessary to leverage the inter-user duplication property of subscription data to optimize the subscription data storage, processing and delivery. In the future “flat” network architecture, MME function may be integrated into eNB. TAU may occur more frequently and hence the subscription data will be transferred more frequently between network nodes. The gain of this optimization would be more significant in the future flat architecture network. This optimization can also act as the solution to M2M subscription data sharing requirement.

In accordance with one or more aspects of the embodiments described herein, there are provided methods for subscription data optimization in a wireless communication system. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

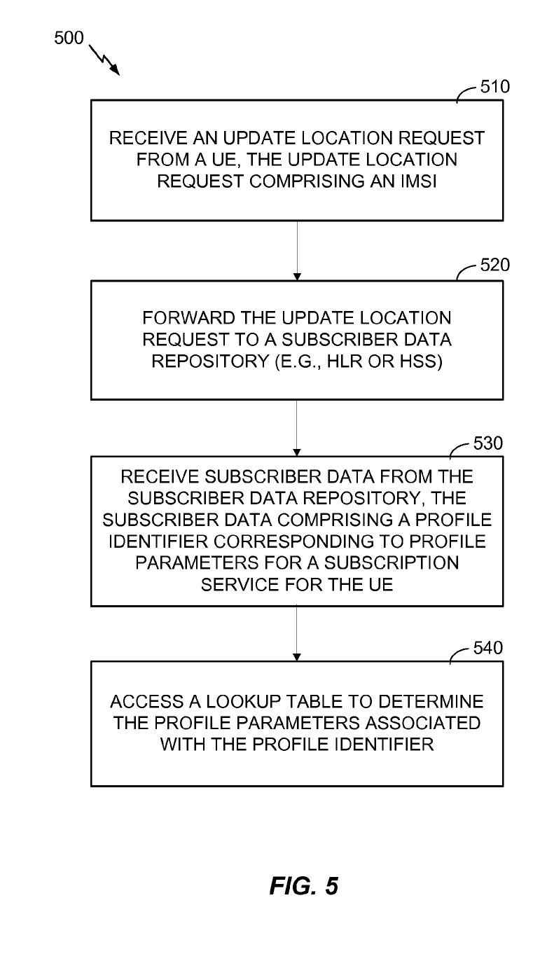

With reference to FIG. 5, illustrated is a methodology 500 for profile parameters determination in a subscription data optimized system. It is noted that method 500 may be performed by an infrastructure entity of a wireless communication systems, such as, for example, a network management entity (e.g., a Serving GPRS Support Node (SGSN), a Mobility Management Entity (MME), a Mobile Switching Center (MSC)/Visitor Location Register (VLR), a Serving Call Session Control Function (S-CSCF), or the like). At 510, a registration request is received from a mobile entity, the update location request comprising an identity of the mobile entity (ME-ID). At 520, an update location request is sent to a subscriber data repository (e.g., a Home Location Register (HLR) and/or a Home Subscriber Server (HSS)). At 530, subscriber data is received from the subscriber data repository, the subscriber data comprising a profile identifier corresponding to profile parameters for a subscription service for the mobile entity. At 540, a lookup table is accessed to determine the profile parameters associated with the profile identifier.

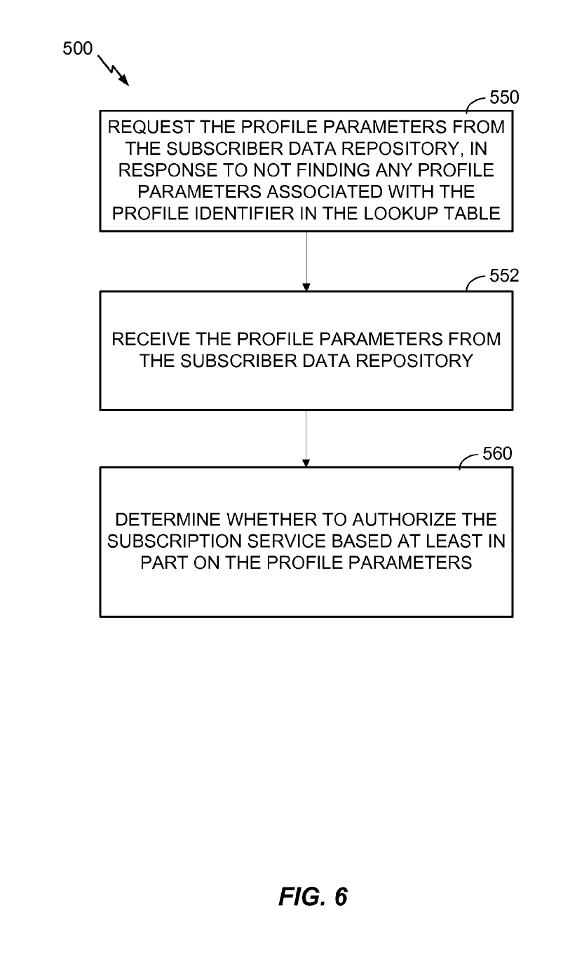

With reference to FIG. 6, the method 500 may involve, at 550, requesting the profile parameters from the subscriber data repository, in response to not finding any profile parameters associated with the profile identifier in the lookup table. The method 500 may involve, at 552, receiving the profile parameters from the subscriber data repository. The method 500 may involve, at 560, determining whether to authorize the subscription service based at least in part on the profile parameters.

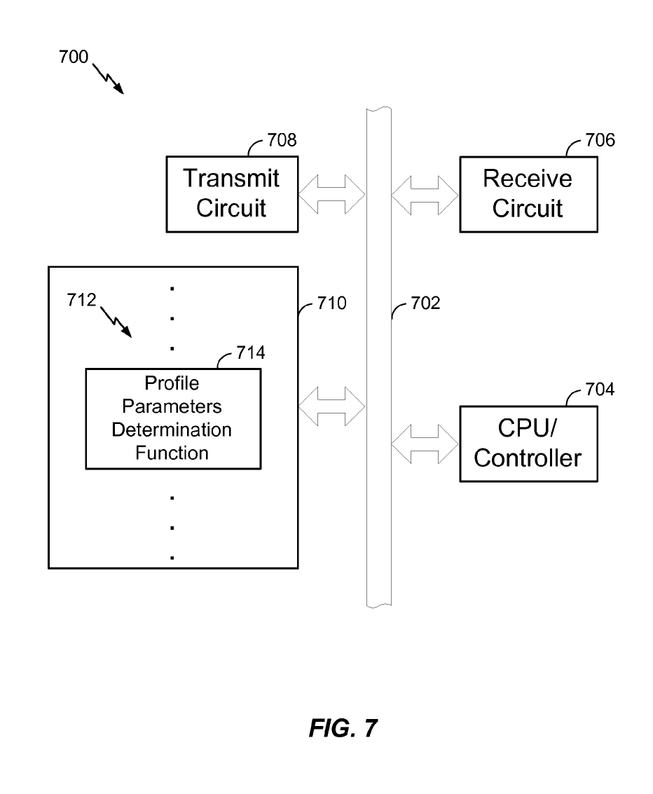

In accordance with one or more aspects of the embodiments described herein, there are provided devices and apparatuses for subscription data optimization in a wireless communication system. FIG. 7 shows hardware implementation of an apparatus for executing the profile parameters determination processes as described above with reference to FIGS. 5-6. The circuit apparatus is signified by the reference numeral 700 and can be implemented in an wireless communication infrastructure entity, such as a network managing entity.

The apparatus 700 comprises a central data bus 702 linking several circuits together. The circuits include a Central Processing Unit (CPU) or a controller 704, a receive circuit 706, a transmit circuit 708, and a memory unit 710. The apparatus 700 may be configured as a communication device (e.g. a SGSN or an MME) or as a processor or similar device for use within the communication device. As depicted, the apparatus 700 may include functional blocks in the memory unit 710 that can represent functions implemented by a processor, software, or combination thereof (e.g., firmware).

If the apparatus 700 is part of a wireless device, the receive and transmit circuits 706 and 708 can be connected to a RF (Radio Frequency) circuit which is not shown in the drawing. The receive circuit 706 processes and buffers received signals before sending out to the data bus 702. On the other hand, the transmit circuit 708 processes and buffers the data from the data bus 702 before sending out of the device 700. The CPU/controller 704 performs the function of data management of the data bus 702 and further the function of general data processing, including executing the instructional contents of the memory unit 710. In related aspects, instead of separately disposed as shown in FIG. 7, as an alternative, the transmit circuit 708 and the receive circuit 706 can be parts of the CPU/controller 704.

The memory unit 710 includes a set of modules and/or instructions generally signified by the reference numeral 712. In this embodiment, the modules/instructions include, among other things, a profile parameters determination function 714. The profile parameters determination function 714 includes computer instructions or code for executing the process steps as shown and described in FIGS. 5-6. Specific instructions particular to an entity can be selectively implemented in the profile parameters determination function 714. For instance, if the apparatus 700 is part of an infrastructure entity, e.g., a network managing entity, process steps along with the relevant messages particular to that communication entity can be coded in the profile parameters determination function 714.

In this embodiment, the memory unit 710 is a RAM (Random Access Memory) circuit. The exemplary functions, such as the handoff function 714, are software routines, modules and/or data sets. The memory unit 710 can be tied to another memory circuit (not shown) which can either be of the volatile or nonvolatile type. As an alternative, the memory unit 710 can be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art.

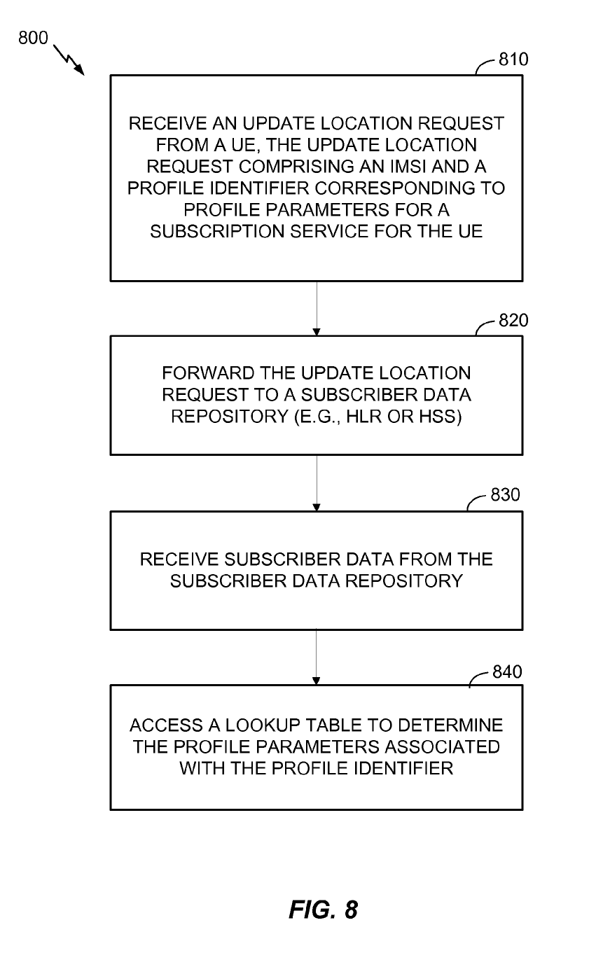

With reference to FIG. 8, there is provided another method 800 for profile parameters determination in a subscription data optimized system, wherein the profile identifier is stored in an user identification module (e.g., USIM, SIM, UIM, or soft SIM) and transmitted from a mobile entity to a network management entity. It is noted that method 800 may be performed at a network management entity or the like. At 810, a registration request is received from the mobile entity, the update location request comprising an identity of the mobile entity (ME-ID) and the profile identifier corresponding to profile parameters for a subscription service for the mobile entity. At 820, an update location request is sent to a subscriber data repository. At 830, subscriber data is received from the subscriber data repository. At 840, a lookup table is accessed to determine the profile parameters associated with the profile identifier.

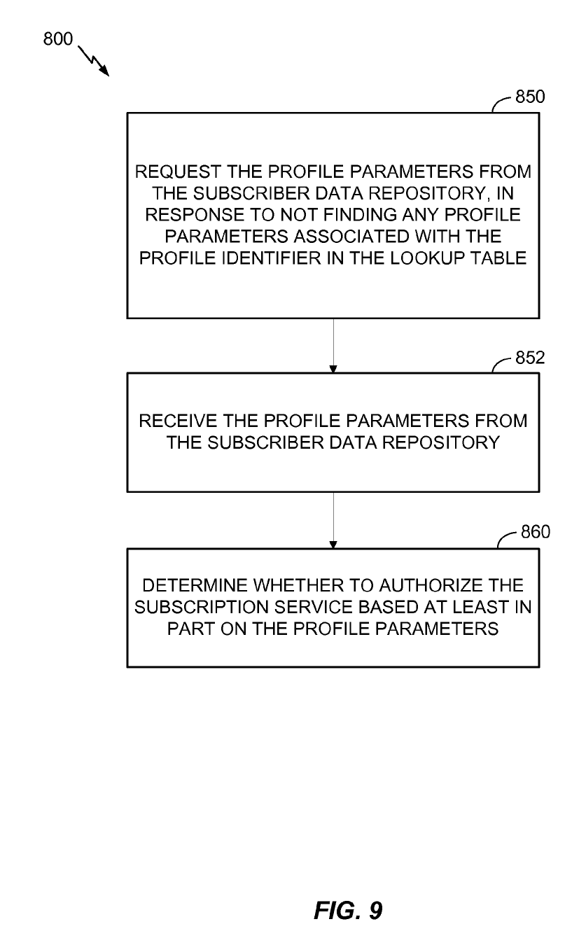

With reference to FIG. 9, the method 800 may involve, at 850, requesting the profile parameters from the subscriber data repository, in response to not finding any profile parameters associated with the profile identifier in the lookup table. The method 800 may involve, at 852, receiving the profile parameters from the subscriber data repository. The method 800 may involve, at 860, determining whether to authorize the subscription service based at least in part on the profile parameters.

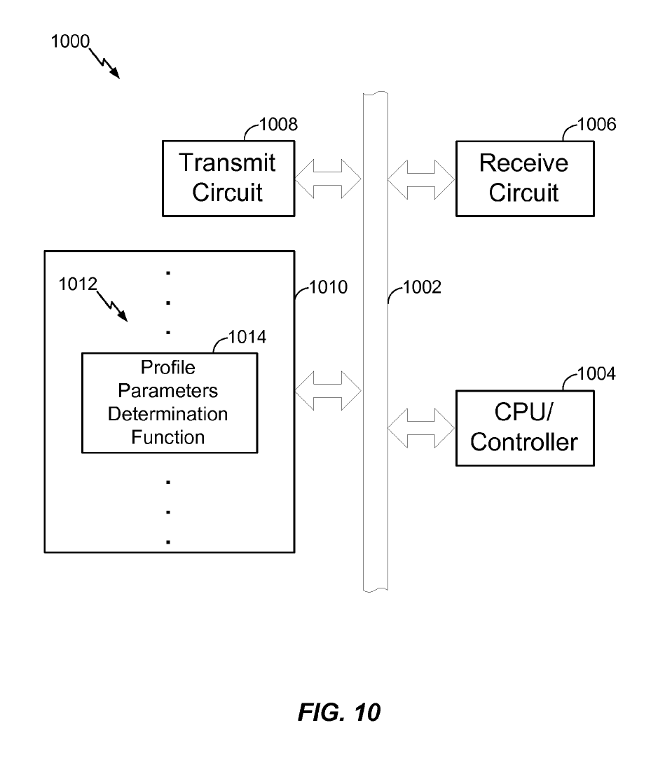

In accordance with one or more aspects of the embodiments described herein, there are provided devices and apparatuses for subscription data optimization in a wireless communication system. FIG. 10 shows hardware implementation of an apparatus for executing the profile parameters determination processes as described above with reference to FIGS. 8-9. The circuit apparatus is signified by the reference numeral 1000 and can be implemented in an wireless communication infrastructure entity, such as a network managing entity.

The apparatus 1000 comprises a central data bus 1002 linking several circuits together. The circuits include a Central Processing Unit (CPU) or a controller 1004, a receive circuit 1006, a transmit circuit 1008, and a memory unit 1010. The apparatus 1000 may be configured as a communication device (e.g. a SGSN or an MME) or as a processor or similar device for use within the communication device. As depicted, the apparatus 1000 may include functional blocks in the memory unit 1010 that can represent functions implemented by a processor, software, or combination thereof (e.g., firmware).

The memory unit 1010 includes a set of modules and/or instructions generally signified by the reference numeral 1012. In this embodiment, the modules/instructions include, among other things, a profile parameters determination function 1014. The profile parameters determination function 1014 includes computer instructions or code for executing the process steps as shown and described in FIGS. 8-9. Specific instructions particular to an entity can be selectively implemented in the profile parameters determination function 1014. For the sake of conciseness, the rest of the details regarding apparatus 1000 are not further elaborated on; however, it is to be understood that the remaining features and aspects of the apparatus 1000 are substantially similar to those described above with respect to apparatus 700 of FIG. 7.

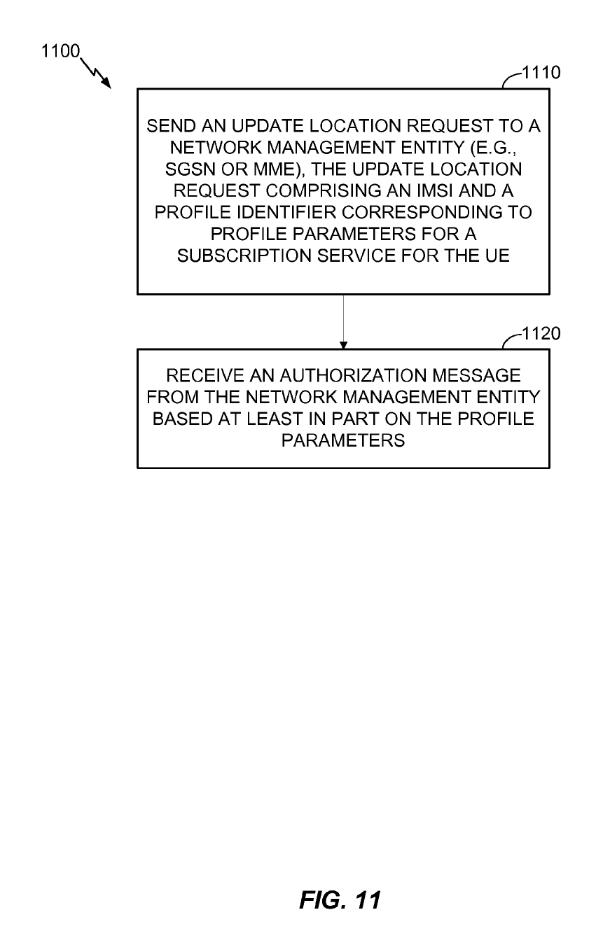

In accordance with one or more aspects of the embodiments described herein and with reference to FIG. 11, illustrated is a methodology 1100 for profile identifier sharing in a subscription data optimized system. It is noted that method 1100 may be performed by a mobile entity or similar networking/communication device. At 1110, a registration request is sent to a network management entity (e.g., an SGSN or a MME), the update location request comprising an identity of the mobile entity (ME-ID) and a profile identifier corresponding to profile parameters for a subscription service for the mobile entity. At 1120, an authorization message is received from the network management entity based at least in part on the profile parameters. For example, the authorization message may comprise one of an approval or denial for the subscription service.

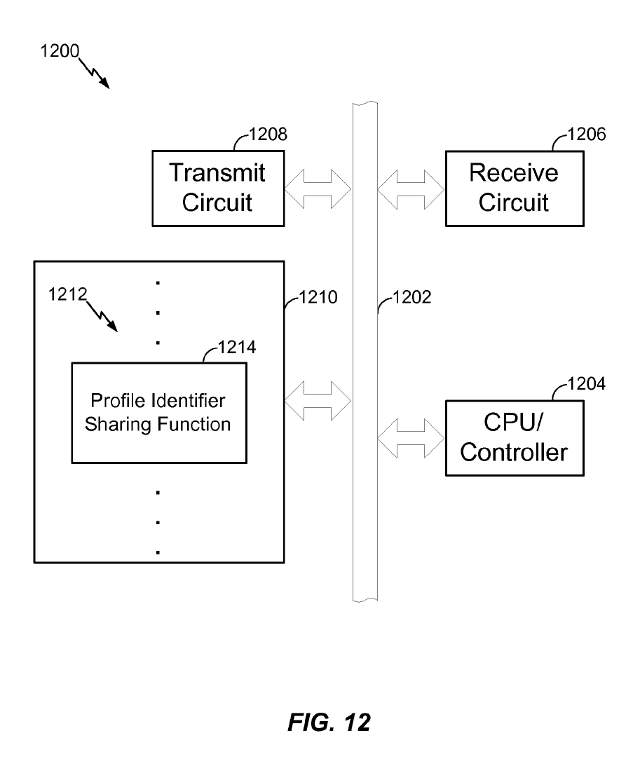

In accordance with one or more aspects of the embodiments described herein, there are provided devices and apparatuses for subscription data optimization in a wireless communication system. FIG. 12 shows hardware implementation of an apparatus for executing the profile identifier sharing processes as described above with reference to FIG. 11. The circuit apparatus is signified by the reference numeral 1200 and can be implemented in a mobile entity.

The apparatus 1200 comprises a central data bus 1202 linking several circuits together. The circuits include a Central Processing Unit (CPU) or a controller 1204, a receive circuit 1206, a transmit circuit 1208, and a memory unit 1210. If the apparatus 1200 is part of a wireless device, the receive and transmit circuits 1206 and 1208 can be connected to a RF (Radio Frequency) circuit which is not shown in the drawing. The memory unit 1210 includes a set of modules and/or instructions generally signified by the reference numeral 1212. In this embodiment, the modules/instructions include, among other things, a profile identifier sharing function 1214.

The profile identifier sharing function 1214 includes computer instructions or code for executing the process steps as shown and described in FIG. 11. Specific instructions particular to an entity can be selectively implemented in the profile identifier sharing function 1214. For the sake of conciseness, the rest of the details regarding apparatus 1200 are not further elaborated on; however, it is to be understood that the remaining features and aspects of the apparatus 1200 are substantially similar to those described above with respect to apparatus 700 of FIG. 7.

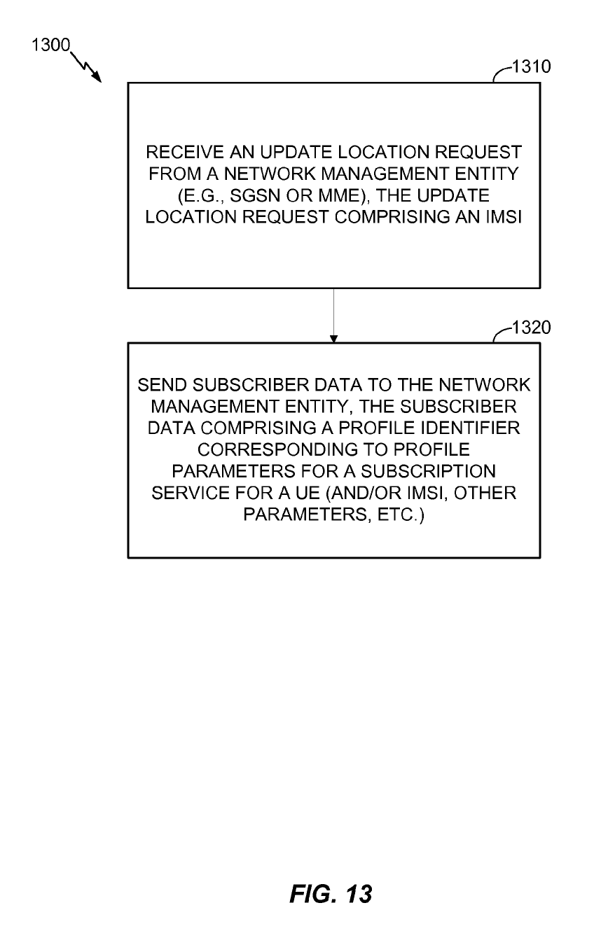

In accordance with one or more aspects of the embodiments described herein and with reference to FIG. 13, illustrated is a methodology 1300 for subscriber data sharing in a subscription data optimized system. It is noted that method 1300 may be performed by an infrastructure entity, such as, for example, a subscriber data repository (e.g., HLR and/or HSS, or the like). At 1310, an update location request is received from a network management entity (e.g., an SGSN or a MME), the update location request comprising a subscriber identifier (e.g., an IMSI or the like). At 1320, subscriber data is sent to the network management entity, the subscriber data comprising a profile identifier corresponding to profile parameters for a subscription service for the mobile entity. The subscriber identifier, and other parameters (i.e., different or supplemental to the profile parameters) may be sent to the network management entity.

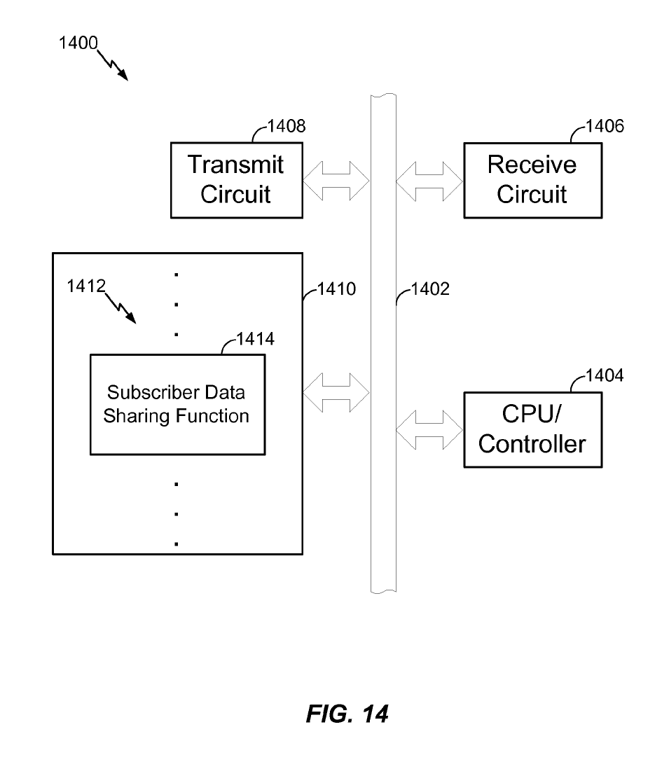

In accordance with one or more aspects of the embodiments described herein, there are provided devices and apparatuses for subscription data optimization in a wireless communication system. FIG. 14 shows hardware implementation of an apparatus for executing the subscriber data sharing processes as described above with reference to FIG. 13. The circuit apparatus is signified by the reference numeral 1400 and can be implemented in an wireless communication infrastructure entity, such as a network managing entity.

The apparatus 1400 comprises a central data bus 1402 linking several circuits together. The circuits include a Central Processing Unit (CPU) or a controller 1404, a receive circuit 1406, a transmit circuit 1408, and a memory unit 1410. If the apparatus 1400 is part of a wireless device, the receive and transmit circuits 1406 and 1408 can be connected to a RF (Radio Frequency) circuit which is not shown in the drawing. The memory unit 1410 includes a set of modules and/or instructions generally signified by the reference numeral 1412. In this embodiment, the modules/instructions include, among other things, a subscriber data sharing function 1414.

The subscriber data sharing function 1414 includes computer instructions or code for executing the process steps as shown and described in FIG. 13. Specific instructions particular to an entity can be selectively implemented in the profile identifier sharing function 1414. For the sake of conciseness, the rest of the details regarding apparatus 1400 are not further elaborated on; however, it is to be understood that the remaining features and aspects of the apparatus 1400 are substantially similar to those described above with respect to apparatus 700 of FIG. 7.

In addition to the implementations as shown and described in FIGS. 7, 10, 12, and 14, it should be further be noted that the inventive processes as described can also be coded as computer-readable instructions carried on any computer-readable medium known in the art. In this specification and the appended claims, the term “computer-readable medium” refers to any medium that participates in providing instructions to any processor, such as the CPU/controllers 704, 1004, 1204, and 1404 shown and described in the drawing figure of FIGS. 7, 10, 12, and 14, respectively, for execution. Such a medium can be of the storage type and may take the form of a volatile or non-volatile storage medium as also described previously, for example, in the description of the memory units 710, 1010, 1210, and 1410 in FIGS. 7, 10, 12, and 14, respectively. Such a medium can also be of the transmission type and may include a coaxial cable, a copper wire, an optical cable, and the air interface carrying acoustic, electromagnetic or optical waves capable of carrying signals readable by machines or computers. The computer-readable medium can be part of a computer product separate from the apparatuses 700, 1000, 1200, and 1400 in FIGS. 7, 10, 12, and 14, respectively.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method operable by a infrastructure entity in a wireless communication system, comprising:
receiving a registration request from a mobile entity, the update location request comprising a mobile entity identity;
sending an update location request to a subscriber data repository;
receiving a profile identifier from the subscriber data repository, the profile identifier corresponding to profile parameters for a subscription service for the mobile entity; and
accessing a lookup table to determine the profile parameters associated with the profile identifier.

2. The method of claim 1, further comprising requesting the profile parameters from the subscriber data repository, in response to not finding any profile parameters associated with the profile identifier in the lookup table.

3. The method of claim 2, further comprising receiving the profile parameters from the subscriber data repository.

4. The method of claim 1, wherein the subscriber data repository comprises one of a Home Location Register (HLR) and a Home Subscriber Server (HSS).

5. The method of claim 1, further comprising determining whether to authorize the subscription service based at least in part on the profile parameters.

6. An electronic device configured to execute the method of claim 1.

7. An apparatus operable in a wireless communication system, comprising:
means for receiving a registration request from a mobile entity, the update location request comprising a mobile entity identity;
means for sending an update location request to a subscriber data repository;
means for receiving a profile identifier from the subscriber data repository, the profile identifier corresponding to profile parameters for a subscription service for the mobile entity; and
means for accessing a lookup table to determine the profile parameters associated with the profile identifier.

8. The apparatus of claim 7, further comprising means for requesting the profile parameters from the subscriber data repository, in response to not finding any profile parameters associated with the profile identifier in the lookup table.

9. The apparatus of claim 8, further comprising means for receiving the profile parameters from the subscriber data repository.

10. The apparatus of claim 7, wherein the subscriber data repository comprises one of a Home Location Register (HLR) and a Home Subscriber Server (HSS).

11. The apparatus of claim 7, further comprising means for determining whether to authorize the subscription service based at least in part on the profile parameters.

12. An apparatus operable in a wireless communication system, comprising:
at least one processor, configured for: receiving a registration request from a mobile entity, the registration request comprising a mobile entity identity; sending an update location request to a subscriber data repository; receiving a profile identifier from the subscriber data repository, the profile identifier corresponding to profile parameters for a subscription service for the mobile entity; and accessing a lookup table to determine the profile parameters associated with the profile identifier; and
a memory coupled to the at least one processor for storing data.

13. The apparatus of claim 12, wherein the at least one processor is further configured for requesting the profile parameters from the subscriber data repository, in response to not finding any profile parameters associated with the profile identifier in the lookup table.

14. The apparatus of claim 13, wherein the at least one processor is further configured for receiving the profile parameters from the subscriber data repository.

15. The apparatus of claim 12, wherein the subscriber data repository comprises one of a Home Location Register (HLR) and a Home Subscriber Server (HSS).

16. The apparatus of claim 12, wherein the at least one processor is further configured for determining whether to authorize the subscription service based at least in part on the profile parameters.

17. A computer program product, comprising:
a computer-readable medium comprising code for causing a computer to:
receive a registration request from a mobile entity, the update location request comprising a mobile entity identity;
sending an update location request to a subscriber data repository;
receive a profile identifier from the subscriber data repository, the profile identifier corresponding to profile parameters for a subscription service for the mobile entity; and
access a lookup table to determine the profile parameters associated with the profile identifier.

18. The computer program product of claim 17, wherein the subscriber data repository comprises one of a Home Location Register (HLR) and a Home Subscriber Server (HSS).

19. A method operable by a infrastructure entity in a wireless communication system, comprising:
receiving a registration request from a mobile entity, the registration request comprising a profile identifier corresponding to profile parameters for a subscription service for the mobile entity; and
accessing a lookup table to determine the profile parameters associated with the profile identifier.

20. The method of claim 19, wherein the registration request further comprises a mobile entity identity.

21. The method of claim 19, further comprising:
sending an update location request to a subscriber data repository; and
receiving subscriber data from the subscriber data repository.

22. The method of claim 19, further comprising requesting the profile parameters from the subscriber data repository, in response to not finding any profile parameters associated with the profile identifier in the lookup table.

23. The method of claim 22, further comprising receiving the profile parameters from the subscriber data repository.

24. The method of claim 19, wherein the subscriber data repository comprises one of a Home Location Register (HLR) and a Home Subscriber Server (HSS).

25. The method of claim 19, further comprising determining whether to authorize the subscription service based at least in part on the profile parameters.

26. An electronic device configured to execute the method of claim 19.

27. An apparatus operable in a wireless communication system, comprising:
means for receiving a registration request from a mobile entity, the registration request comprising a profile identifier corresponding to profile parameters for a subscription service for the mobile entity; and
means for accessing a lookup table to determine the profile parameters associated with the profile identifier.

28. The apparatus of claim 27, wherein the registration request further comprises a mobile entity identity.

29. The apparatus of claim 27, further comprising:
means for sending an update location request to a subscriber data repository; and
means for receiving subscriber data from the subscriber data repository.

30. The apparatus of claim 27, further comprising means for requesting the profile parameters from the subscriber data repository, in response to not finding any profile parameters associated with the profile identifier in the lookup table.

31. The apparatus of claim 30, further comprising means for receiving the profile parameters from the subscriber data repository.

32. The apparatus of claim 27, wherein the subscriber data repository comprises one of a Home Location Register (HLR) and a Home Subscriber Server (HSS).

33. The apparatus of claim 27, further comprising means for determining whether to authorize the subscription service based at least in part on the profile parameters.

34. An apparatus operable in a wireless communication system, comprising:
at least one processor, configured for: receiving a registration request from a mobile entity, the registration request comprising a profile identifier corresponding to profile parameters for a subscription service for the mobile entity; and accessing a lookup table to determine the profile parameters associated with the profile identifier; and
a memory coupled to the at least one processor for storing data.

35. The apparatus of claim 34, wherein the registration request further comprises a mobile entity identity.

36. The apparatus of claim 34, wherein the at least one processor is further configured for sending an update location request to a subscriber data repository, and receiving subscriber data from the subscriber data repository.

37. The apparatus of claim 34, wherein the at least one processor is further configured for requesting the profile parameters from the subscriber data repository, in response to not finding any profile parameters associated with the profile identifier in the lookup table.

38. The apparatus of claim 37, wherein the at least one processor is further configured for receiving the profile parameters from the subscriber data repository.

39. The apparatus of claim 34, wherein the subscriber data repository comprises one of a Home Location Register (HLR) and a Home Subscriber Server (HSS).

40. The apparatus of claim 34, wherein the at least one processor is further configured for determining whether to authorize the subscription service based at least in part on the profile parameters.

41. A computer program product, comprising:
a computer-readable medium comprising code for causing a computer to:
receive a registration request from a mobile entity, the registration request comprising a profile identifier corresponding to profile parameters for a subscription service for the mobile entity; and
access a lookup table to determine the profile parameters associated with the profile identifier.

42. The computer program product of claim 41, wherein the registration request further comprises a mobile entity identity.

43. The computer program product of claim 41, wherein the subscriber data repository comprises one of a Home Location Register (HLR) and a Home Subscriber Server (HSS).

44. A method operable by a mobile entity in a wireless communication system, comprising:
sending a registration request to a network management entity, the registration request comprising a mobile entity identity and a profile identifier corresponding to profile parameters for a subscription service for the mobile entity; and
receiving an authorization message from the network management entity based at least in part on the profile parameters.

45. The method of claim 44, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

46. The method of claim 44, wherein the authorization message comprises one of an approval or denial for the subscription service.

47. An electronic device configured to execute the method of claim 44.

48. An apparatus operable in a wireless communication system, comprising:
means for sending a registration request to a network management entity, the registration request comprising a mobile entity identity and a profile identifier corresponding to profile parameters for a subscription service for a mobile entity; and
means for receiving an authorization message from the network management entity based at least in part on the profile parameters.

49. The apparatus of claim 48, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

50. The apparatus of claim 48, wherein the authorization message comprises one of an approval or denial for the subscription service.

51. An apparatus operable in a wireless communication system, comprising:
at least one processor, configured for: means for sending a registration request to a network management entity, the registration request comprising a mobile entity identity and a profile identifier corresponding to profile parameters for a subscription service for a mobile entity; and means for receiving an authorization message from the network management entity based at least in part on the profile parameters; and
a memory coupled to the at least one processor for storing data.

52. The apparatus of claim 51, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

53. The apparatus of claim 51, wherein the authorization message comprises one of an approval or denial for the subscription service.

54. A computer program product, comprising:
a computer-readable medium comprising code for causing a computer to:
send a registration request to a network management entity, the registration request comprising a mobile entity identity and a profile identifier corresponding to profile parameters for a subscription service for a mobile entity; and
receive an authorization message from the network management entity based at least in part on the profile parameters.

55. The computer program product of claim 54, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

56. The computer program product of claim 54, wherein the authorization message comprises one of an approval or denial for the subscription service.

57. A method operable by a infrastructure entity in a wireless communication system, comprising:
receiving an update location request from a network management entity, the update location request comprising a subscriber identifier; and
sending a profile identifier to the network management entity, the profile identifier corresponding to profile parameters for a subscription service for a mobile entity.

58. The method of claim 57, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

59. The method of claim 57, wherein sending comprises transmitting the subscriber identifier and other parameters to the network management entity.

60. The method of claim 57, wherein the subscriber identifier comprises an International Mobile Subscriber Identity (IMSI).

61. An electronic device configured to execute the method of claim 57.

62. An apparatus operable in a wireless communication system, comprising:
means for receiving an update location request from a network management entity, the update location request comprising a subscriber identifier; and
means for sending a profile identifier to the network management entity, the profile identifier corresponding to profile parameters for a subscription service for a mobile entity.

63. The apparatus of claim 62, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

64. The apparatus of claim 62, wherein the means for sending further comprises means for transmitting the subscriber identifier and other parameters to the network management entity.

65. An apparatus operable in a wireless communication system, comprising:
at least one processor, configured for: receiving an update location request from a network management entity, the update location request comprising a subscriber identifier; and sending a profile identifier to the network management entity, the profile identifier corresponding to profile parameters for a subscription service for a mobile entity; and
a memory coupled to the at least one processor for storing data.

66. The apparatus of claim 65, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).

67. The apparatus of claim 65, wherein the at least one processor is further configured for transmitting the subscriber identifier and other parameters to the network management entity.

68. A computer program product, comprising:
a computer-readable medium comprising code for causing a computer to:
receive an update location request from a network management entity, the update location request comprising a subscriber identifier; and
send a profile identifier to the network management entity, the profile identifier corresponding to profile parameters for a subscription service for a mobile entity.

69. The computer program product of claim 68, wherein the network management entity comprises one of a Serving GPRS Support Node (SGSN), a Mobility Management Entity (MME), a Mobile Switching Center (MSC)/Visitor Location Register (VLR), and a Serving Call Session Control Function (S-CSCF).
